(19) United States
(12) Patent Application Publication
(10) Pub. No.: US 2011/0125949 A1
(43) Pub. Date: May 26, 2011

(54) Routing packet from first virtual machine to second virtual machine of a computing device

(76) Inventors: Jayaram Mudigonda, San Jose, CA (US); Paul T. Congdon, Granite Bay, CA (US); Jose Renato G. Santos, San Jose, CA (US); Parthasarathy Ranganathan, Fremont, CA (US)

(21) Appl. No.: 12/623,428

(22) Filed: Nov. 22, 2009

(51) Int. Cl. G06F 13/36; G06F 13/14

(52) U.S. Cl. 710/308; 710/305

(57) ABSTRACT

A networking packet is to be sent from a first virtual machine of a computing device to a second virtual machine of the computing device. A hardware network interface controller (NIC) of the computing device is to determine whether the networking packet is to be routed from the first virtual machine to the second virtual machine in accordance with a first approach or a second approach, based upon one or more considerations regarding a state of the computing device. The hardware NIC is then to control routing of the networking packet in accordance with the first approach or the second approach.

### BACKGROUND

An increasingly popular type of computer architecture is one that employs virtual machines. One or more computing devices host one or more virtual machines, each of which can correspond to a different end user. Each end user uses a terminal, or other type of client computing device that is communicatively connected to the computing devices, to provide input to a virtual machine and to receive output from the virtual machine. Processing of the input to generate the output, however, is handled by the computing devices that host the virtual machines. Each virtual machine has its own dedicated copy of an operating system, which is referred to as a guest operating system and that is installed at the computing devices. The terminals or other types of client computing devices thus perform limited or no processing functionality.

### BRIEF DESCRIPTION OF THE DRAWINGS

FIG. 1 is a diagram of a computing device in which networking packets can be routed in an inter-computing device manner or in an intra-computing device manner, according to an example embodiment of the present disclosure.

FIG. 2 is a flowchart of a method for routing a networking packet, according to an example embodiment of the present disclosure.

FIG. 3 is a flowchart of a method for routing a networking packet in an intra-computing device manner in accordance with a first approach, according to an example embodiment of the disclosure.

FIG. 4 is a flowchart of a method for routing a networking packet in an intra-computing device manner, in accordance with a second approach, according to an example embodiment of the disclosure.

FIG. 5 is a diagram of a hardware network interface controller (NIC), according an example embodiment of the present disclosure.

FIG. 6 is a diagram of a computer-readable storage medium, according to an example embodiment of the present disclosure.

### DETAILED DESCRIPTION

As noted in the background section, virtual machines have become increasingly popular. A computing device may host more than one virtual machine. Each virtual machine is considered a “machine within the machine” and functions as if it owned the entire computing device. Therefore, functionality that a computing device can normally perform in relation to another computing device, such as sending packets of data over a network, which are referred to herein as networking packets, can also be performed by one virtual machine in relation to another virtual machine.

In one conventional technique, networking packets generated at a virtual machine hosted by a computing device are transmitted to a hardware network interface controller (NIC) of the computing device. If a networking packet is intended for a different computing device, the hardware NIC routes the packet over a network external to the computing device that hosts the virtual machine. If a networking packet is intended for a different virtual machine hosted by the same computing device, the hardware NIC routes the packet to this virtual machine.

This existing technique can result in performance degradation. A hardware input/output (I/O) bus for the hardware NIC bandwidth can become bottlenecked. This is because all networking packets generated within the computing device are handled by the hardware NIC and thus are transmitted over the hardware I/O bus, including packets from one first virtual machine to another virtual machine hosted by the computing device, as well as packets from virtual machines hosted by the computing device to different computing devices.

In another conventional technique, networking packets generated at a virtual machine hosted by a computing device are first processed in software. If a networking packet is intended for a different computing device, the software transmits the packet to a hardware NIC, which routes the networking packet over a network external to the computing device that hosts the virtual machine. If a networking packet is intended for a different virtual machine hosted by the same computing device, the software routes the packet to this virtual machine.

This existing technique can also result in performance degradation. The processors of the computing device that execute the software can become overburdened. This is because all the networking packets generated within the computing device are handled by the software that is executed by the processors, including packets from one first virtual machine to another virtual machine hosted by the computing device, as well as packets from virtual machines hosted by the computing device to different computing devices.

By comparison, the technique that is disclosed herein determines whether a networking packet should be routed from one virtual machine to another virtual machine within the same computing device in accordance with a first approach or a second approach. The determined approach is then used to control routing of the networking packet between the virtual machines. Thus, the same approach is not employed to route networking packets between virtual machines within the same computing device. Rather, logic is used to determine whether the first approach or the second approach should be used to route a given networking packet between virtual machines within the same computing device, based upon one or more considerations of the current state of the computing device.

In the first approach, the networking packet can be routed from the first virtual machine to the second virtual machine by a hardware NIC over a hardware I/O bus of the computing device. In the second approach, the networking packet can instead be routed from the first virtual machine to the second virtual machine through a third, intermediary virtual machine hosted by the same computing device. The intermediary virtual machine is more generally a computer program.

The first approach uses the hardware NIC and the hardware I/O bus of the computing device, but not any processors of the computing device. The second approach uses one or more processors of the computing device—since the intermediary virtual machine (or other computer program) is software that is executed by the processors—but not the hardware NIC or the hardware I/O bus. Therefore, there is flexibility in selecting which approach should be used to send a given networking packet from the first virtual machine to the second virtual machine hosted by the same computing device, based upon one or more considerations regarding the state of the computing device.

For example, if the hardware I/O bus is currently bottlenecked, the networking packet may be sent in accordance with the second approach, which does not use the hardware I/O bus. Similarly, if the processors are currently overburdened, the networking packet may be sent in accordance with the first approach, which does not use the processors. Therefore, the disclosed approach can avoid and prevent bottlenecking the hardware I/O bus and overburdening the processors. Other considerations may also be employed to determine which approach to use to send a networking packet from the first virtual machine to the second virtual machine hosted by the same computing device.

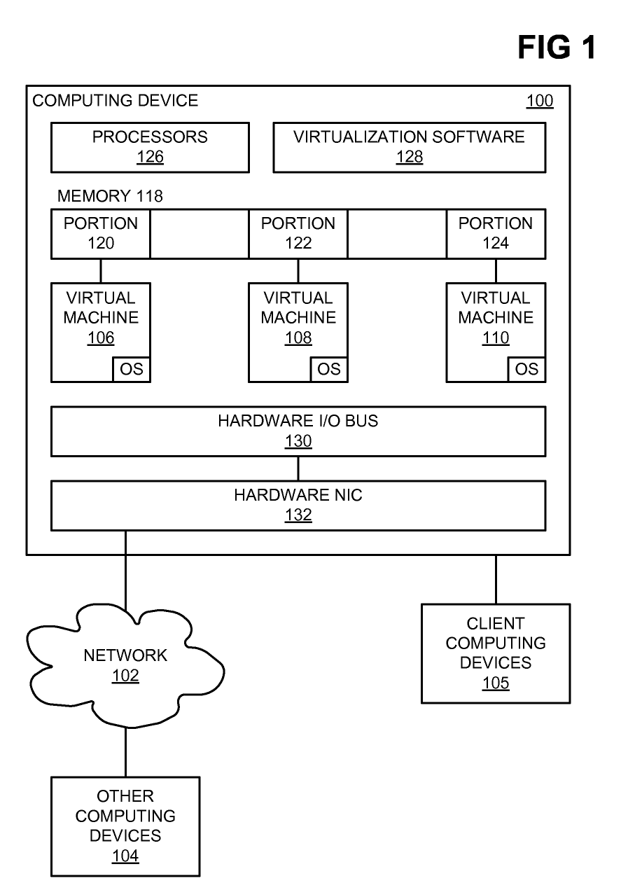

FIG. 1 shows a computing device 100, according to an embodiment of the disclosure. The computing device 100 is communicatively connected to other computing devices 104 and to client computing devices 105. As depicted in FIG. 1, the computing device 100 is indirectly connected to the computing devices 104 over a network 102, whereas the device 100 is directly connected to the computing devices 105. However, alternatively the client computing devices 105 may also be indirectly connected to the computing device 100 over the network 102.

Each of the computing devices 100, 104, and 105 includes hardware, such as one or more processors, memory, input devices, output devices, network devices and other types of hardware devices. As to the computing devices 104, the computing device 100 can generate networking packets that are transmitted to the devices 104 over the network 102, and can similarly receive networking packets from the devices 104 over the network 102. As to the computing devices 104, users provide input at the client computing devices 105, which is sent to the computing devices 100 for processing to generate output. The output is then sent from the computing devices 100 back to the client computing devices 105, at which the output is displayed for the users.

In this latter respect, the computing device 100 includes virtual machines 106, 108, and 110 having operating systems 112, 114, and 116, respectively, and that run on and that are implemented by the hardware, which includes one or more processors 126, of the computing devices 100. A virtual machine is an instance of an operating system along with one or more applications running in an isolated partition within the computing device 100. Virtual machines permit the same or different operating systems to run on the same computing device 100 at the same time while preventing the virtual machines from interfering with each other. Each virtual machine is considered a “machine within the machine” and functions as if it owned an entire computing device, as noted above.

The operating systems 112, 114, and 116 can be referred to as guest operating systems, and can be the same or different versions of the same or different operating systems. Such operating systems may include versions of the LINUX® operating system, where LINUX® is a trademark of Linus Torvalds. Such operating systems may further include versions of the Microsoft®Windows® operating system, where Microsoft® and Windows® are trademarks of Microsoft Corp., of Redmond, Wash.

Virtualization software 128 manages the virtual machines 106, 108, and 110. The virtualization software 128 may also be referred to as a virtual machine monitor (VMM) or a hypervisor. An example of virtualization software 128 is Xen® virtual machine software, available from Citrix Systems, Inc., of Ft. Lauderdale, Fla. Another example of virtualization software 128 is VMware® virtual machine software, available from VMware, Inc., of Palo Alto, Calif. The virtualization software 128 manages the virtual machines 106, 108, and 110 in that, among other things, the software 128 controls the instantiation, migration, and deletion of the virtual machines 106, 108, and 110.

The computing device 100 includes memory 118, which is hardware memory in that, for instance, it can be semiconductor memory like dynamic random access memory (DRAM). Each virtual machine is assigned a dedicated portion of the memory 118, which is used by the virtual machine as implemented by the processors 126. Specifically, the virtual machines 106, 108, and 110 are assigned the portion 120, 122, and 124, respectively of the memory 118.

Each virtual machine normally is permitted by the virtualization software 128 to access just the portion of memory to which it has been assigned. For example, the virtual machine 106 is normally permitted to access just the portion 120 of the memory 118, and not other portions of the memory 118, such as the portions 122 and 124 assigned to the virtual machines 108 and 110, respectively. In the embodiment of FIG. 1, however, the virtual machine 108 has privileges accorded by the virtualization software 128 to access the portions 120 and 124 of the memory 118 assigned to the virtual machines 106 and 110, respectively, as well as to access its own portion 122 of the memory 118 as is customary.

The computing device 100 also includes a hardware NIC 132 that communicatively connects the computing device 100 to the network 102. The hardware NIC 132 is itself communicatively and physically connected to a hardware I/O bus 130 within the computing device 100. The NIC 132 and the I/O bus 130 are hardware in that neither is implemented as software executed by the processors 126. For example, the functionality performed by the NIC 132 does not rely on any software of the NIC 132 being executed by the processors 126. The I/O bus 130 may be a peripheral component interconnect (PCI) Express (PCIe) bus in one embodiment.

The hardware NIC 132 transmits networking packets from the computing device 100 intended for the other computing devices 104 over the network 102 so that the devices 104 receive these networking packets. Such networking packets may be generated by the virtual machines 106, 108, and 110, for instance. Similarly, the NIC 132 receives networking packets from the other computing devices 104 over the network 102 that are intended for the computing device 100. Such networking packets may be intended for the virtual machines 106, 108, and 110, for instance.

Besides networking packets being generated at the computing device 100 that are intended for the other computing devices 104, networking packets can also be generated at the device 100 by the virtual machines 106, 108, and 110 that are intended for other of the virtual machines 106, 108, and 110. These latter networking packets are not transmitted over the network 102, since both the sending virtual machine and the receiving virtual machine are part of the same computing device 100. Networking packets can thus be generated at the computing device 100 that are transmitted over the network 102 to the other computing devices 104 in an inter-computing device manner, as well as that are transmitted within the computing device 100 in an intra-computing device manner.

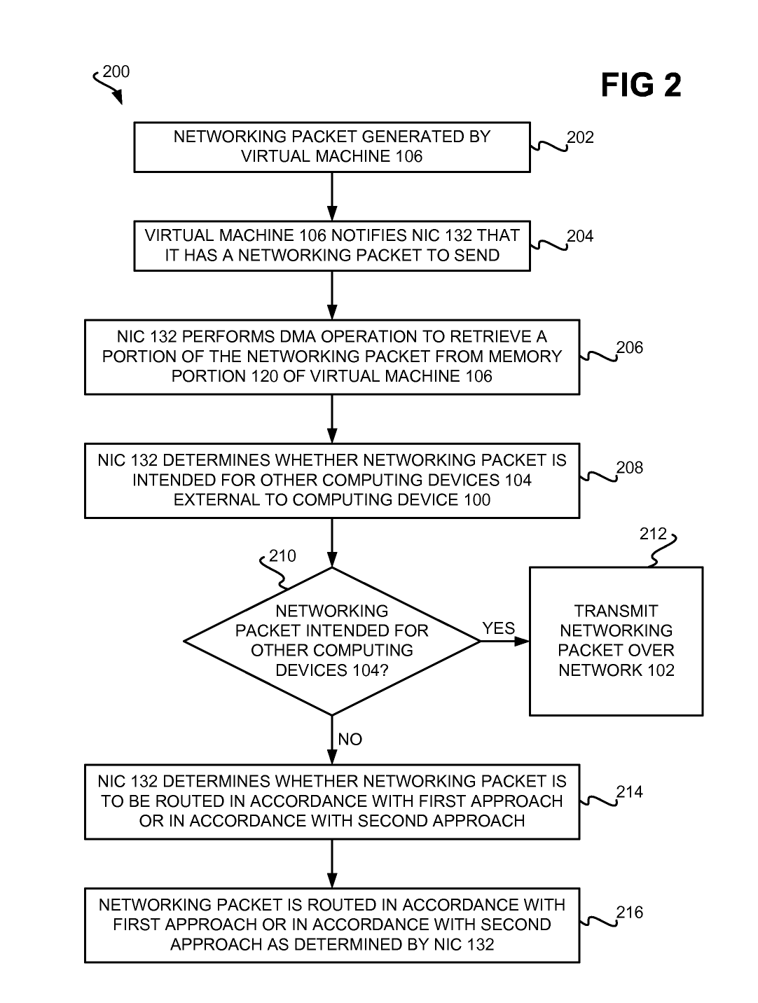

FIG. 2 shows a method 200 for routing networking packets generated at or within the computing device 100, according to an embodiment of the disclosure. The method 200 is performed by the hardware NIC 132, except where otherwise indicated. A networking packet is generated by the virtual machine 106 of the computing device 100 (202). The networking packet is stored in the memory portion 120 of the virtual machine 106. The virtual machine 106 notifies the hardware NIC 132 that the virtual machine 106 has a networking packet to send (204).

In response, the hardware NIC 132 retrieves just a portion of the networking packet from the memory portion 120 of the virtual machine 106 (206), through the hardware I/O bus 130, by performing a direct memory access (DMA) operation in relation to the memory 120. The hardware NIC 132 does not retrieve the entire networking packet from the memory portion 120 at this time, which reduces congestion of the hardware I/O bus 130, since the entire packet is not communicated through the I/O bus 130. More specifically, the hardware NIC 132 retrieves at least a portion of the header information of the networking packet, which indicates the recipient of the networking packet generated by the virtual machine 106.

The hardware NIC 132 then determines whether the networking packet is intended for the other computing devices 104 external to the computing device 100 (208), or in the specific example of FIG. 2, is intended for the virtual machine 110 hosted by the same computing device 100. The hardware NIC 132 makes this determination based on the contents of the portion of the networking packet the NIC 132 retrieved from the memory portion 120 in part 206. The hardware NIC 132 does not make this determination based on the networking packet in its entirety. The hardware NIC 132 may, for instance, compare the networking address of the recipient that is identified in this portion of the networking packet. If the networking address in the networking packet is not one of the networking addresses of one of the other virtual machines hosted by the computing device 100, for instance, the hardware NIC 132 can conclude that the networking packet is intended for the other computing devices 104.

If the networking packet is intended for the other computing devices 104 (210)—that is, if the networking packet is not intended for one of the other virtual machines hosted by the same computing device 100—then the hardware NIC 132 transmits the networking packet over the network 102 for receipt by the other computing devices 104 (212). For instance, the hardware NIC 132 retrieves the remainder of the networking packet that was not previously received in part 206, again by performing a DMA operation in relation to the memory portion 120, such that the NIC 132 receives the remainder of the packet through the hardware I/O bus 130. The hardware NIC 132 then sends the complete networking packet over the network 102.

By comparison, if the networking packet is not intended for the other computing devices 104 (210)—such that the networking packet is intended for the virtual machine 110 in the example of FIG. 2—then the hardware NIC 132 performs the following. The hardware NIC 132 determines whether the networking packet should be routed either in accordance with a first approach or in accordance with a second approach (214). The hardware NIC 132 then controls routing of the networking packet so that it is routed in accordance with either the first approach or the second approach (216).

It is noted that a special type of networking packet is a multicast or a broadcast networking packet, which is intended for a number of recipients, and not just one recipient. A multicast or a broadcast networking packet may therefore be intended for one or more of the virtual machines within the computing device 100, as well as for one or more of the other computing devices 104. As a result, in the method 200, the evaluation that occurs in part 210 cause both part 212 and parts 214 and 216 to be performed. That is, the multicast or broadcasting networking packet as intended for one or more of the other computing devices 104 will result in part 212 being performed, and as intended for one or more of the virtual machines within the computing device 100 will result in parts 214 and 216 being performed.

In the first approach, the networking packet is routed over the hardware I/O bus 130 from the virtual machine 106 to the virtual machine 110, by the hardware NIC 132. By comparison, in the second approach, the networking packet is routed through the intermediary virtual machine 108 (or other computer program) from the virtual machine 106 to the virtual machine 110. The first approach thus uses the hardware NIC 132 and the hardware I/O bus 130, but not the processors 126, whereas the second approach uses the virtual machine 108 and therefore the processors 126, but not the NIC 132 or the I/O bus 130.

The hardware NIC 132 determines whether the networking packet should be routed in part 214 in accordance with the first approach or the second approach based one or more of any number of different considerations regarding the current state of the computing device 100. One exemplary consideration is the current congestion on the hardware I/O bus 130. If enough other data is currently being transmitted over the hardware I/O bus 130, for instance, then the hardware NIC 132 may decide not to add to such congestion, or that such existing congestion may result in routing of the networking packet occurring too slowly if the I/O bus 130 were used. Therefore, the hardware NIC 132 may decide that the second approach should used to route the networking packet.

Another, similar, exemplary consideration is the currently available capacity of the processors 126 that run the virtual machines 106, 108, and 110. If the processors 126 are currently performing many other tasks, such that their utilization is close to their capacity, then the hardware NIC 132 may decide not to add to such utilization, or that such existing utilization may result in routing of the networking packet occurring too slowly if the intermediary virtual machine 108 were used. Therefore, the hardware NIC 132 may decide that the first approach should be used to route the networking packet.

In these respects, additional exemplary considerations include the quality of service (QoS) requirements of the virtual machine 106 as well as the QoS requirements of the virtual machine 110. The QoS requirements may specify how quickly data packets intended for the virtual machine 110 are to be received by the virtual machine 110, as well as how quickly data packets sent by the virtual machine 106 are to be received by the recipients of these data packets. As one example, one approach may be the default approach for routing networking packets from the virtual machine 106 to the virtual machine 110, such that the other approach is used just if the default approach cannot guarantee the QoS requirements of either or both the virtual machines 106 and 110.

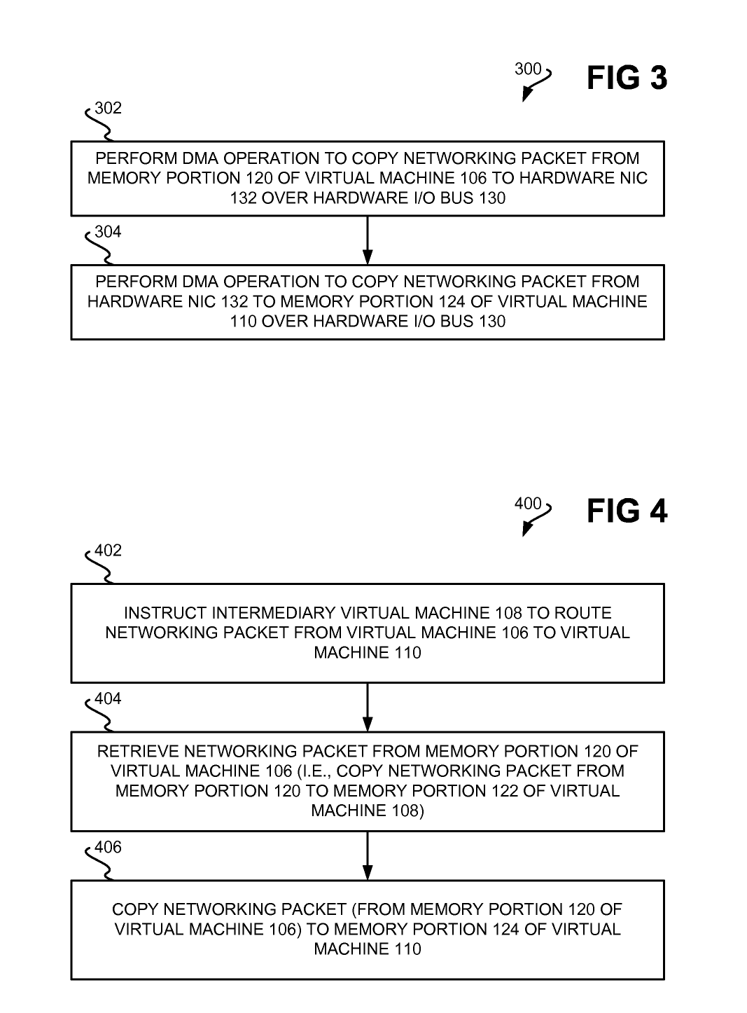

FIG. 3 shows a method 300 that more specifically depicts the first approach for routing the networking packet from the virtual machine 106 to the virtual machine 110, according to an embodiment of the disclosure. The method 300 is performed by the hardware NIC 132. The hardware NIC 132 performs a DMA operation to copy the networking packet (such as the remainder of the networking packet that was not copied in part 206 of FIG. 2) from the memory portion 120 of the virtual machine 106 to the NIC 132 over the hardware I/O bus 130 (302). The hardware NIC 132 then performs another DMA operation to copy the networking packet in its entirety from the NIC 132 to the memory portion 124 of the virtual machine 110 over the hardware I/O bus 130 (304).

FIG. 4 shows a method 400 that more specifically depicts the second approach for routing the network packet from the virtual machine 106 to the virtual machine 110, according to an embodiment of the disclosure. The method 400 is performed by the intermediary virtual machine 108, except where otherwise indicated. The hardware NIC 132 instructs the intermediary virtual machine 108 to route the networking packet from the virtual machine 106 to the virtual machine 110 (402).

The intermediary virtual machine 108 retrieves the networking packet from the memory portion 120 of the virtual machine 106 (404). That is, the intermediary virtual machine 108, as executed by the processors 126, copies the networking packet from the memory portion 120 of the virtual machine 106 to the memory portion 122 of the virtual machine 108. The intermediary virtual machine 108 then copies the networking packet to the memory portion 124 of the virtual machine 110 (406). That is, the intermediary virtual machine 108, as executed by the processors 126, copies the networking packet from the memory portion 122 of the virtual machine 108 to the memory portion 124 of the virtual machine 110.

The method 400 has been described in relation to the intermediary virtual machine 108 routing the network packet from the virtual machine 106 to the virtual machine 110. However, more generally, a computer program routes the networking packet from the virtual machine 106 to the virtual machine 110, where this computer program is executed by the processors 126. The intermediary virtual machine 108 as described herein is an example of this computer program in this respect. However, other types of software code may instead be employed to route the networking packet from the virtual machine 106 to the virtual machine 110 in the method 400. The computer program thus is run on the processors 126, and does not have to be a virtual machine.

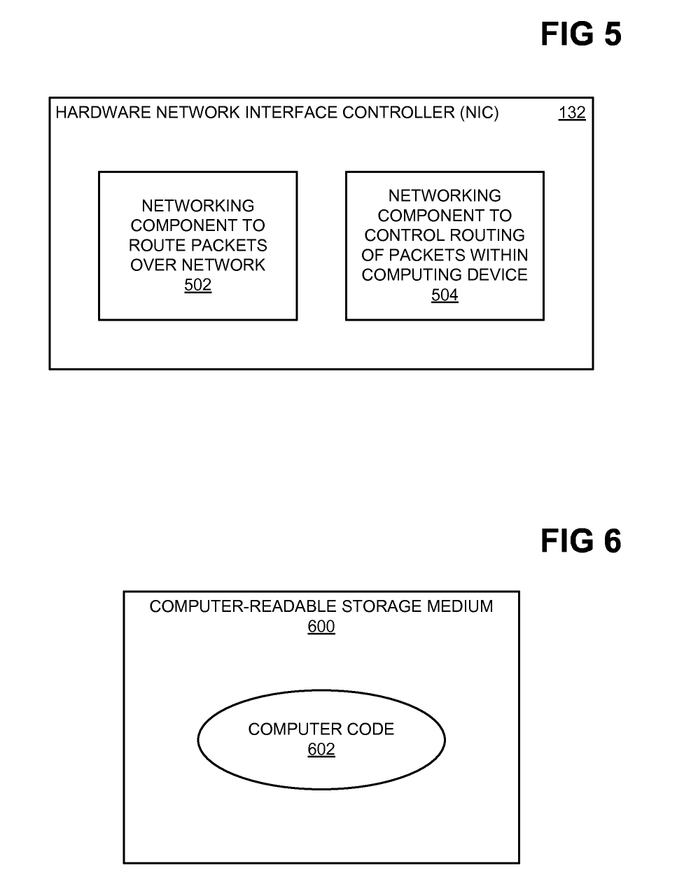

FIG. 5 shows the hardware NIC 132 in rudimentary detail, according to an embodiment of the disclosure. The hardware NIC 132 includes two networking components 502 and 504, both of which are implemented at least in hardware. To the extent that the networking components 502 and 504 may be implemented in software, the software is not executed by the processors 126 of the computing device 100, but rather by processors that are internal to the hardware NIC 132.

The networking component 502 routes networking packets generated at or by the virtual machines 106, 108, and 110 that are intended for the other computing devices 104. As such, the networking component 502 routes these networking packets over the network 102 to the other computing devices 104. By comparison, the networking component 504 controls routing of networking packets generated at or by the virtual machines 106, 108, and 110 that are intended for other of the virtual machines 106, 108, and 110. As such, the networking component 502 controls routing of these networking components within the computing device 100, in accordance with the first approach and the second approach that have been described. The networking component 502 thus can perform at least some parts of the functionality ascribed to the hardware NIC 132 in the methods 200, 300, and 400 of FIGS. 2, 3, and 4.

Furthermore, FIG. 6 shows a rudimentary computer-readable storage medium 600, according to an embodiment of the disclosure. The computer-readable storage medium 600 may be a volatile or a non-volatile storage medium. An example of volatile computer-readable storage media is dynamic random access memory (DRAM), among other types of volatile semiconductor memory. Examples of non-volatile computer-readable storage media include magnetic media, such as hard disk drives, optical media, such as optical discs, and non-volatile semiconductor memory, such as flash memory.

The computer-readable storage medium 600 has stored thereon computer-readable code 602. The computer-readable code 602 is executable by one or more processors of one or more computing devices, such as the processors 126 of the computing device 100. Execution of the computer-readable code 602 programs the hardware NIC 132 so that the NIC 132 determines whether a networking packet sent from the virtual machine 106 and intended for the virtual machine 110 is routed in accordance with the first approach or the second approach. This determination is based upon one or more considerations regarding the state of the computing device 100, as has been described.

We claim:

1. A computing device comprising:
a first virtual machine and a second virtual machine, where a networking packet is to be sent from the first virtual machine to the second virtual machine; and,
a hardware network interface controller (NIC) to determine whether the networking packet is to be routed from the first virtual machine to the second virtual machine within the computing device in accordance with a first approach or a second approach, based upon one or more considerations regarding a state of the computing device,
wherein the hardware NIC is then to control routing of the networking packet in accordance with the first approach or the second approach.

2. The computing device of claim 1, further comprising a hardware input/output (I/O) bus to which the hardware NIC is communicatively connected,
wherein the first approach comprises routing the networking packet over the hardware I/O bus from the first virtual machine to the second virtual machine, by the hardware NIC,
and wherein the second approach comprises routing the networking packet from the first virtual machine to the second virtual machine by using a computer program and one or more processors of the computing device to execute the computer program.

3. The computing device of claim 1, further comprising one or more processors via which the first virtual machine and the second virtual machine are run,
wherein the first approach does not use the processors to route the networking packet from the first virtual machine to the second virtual machine,
and wherein the second approach uses the processors to route the networking packet from the first virtual machine to the second virtual machine.

4. The computing device of claim 1, further comprising:
a hardware input/output (I/O) bus to which the hardware NIC is communicatively connected; and,
a hardware memory having a first memory portion assigned to the first virtual machine and a second memory portion assigned to the second virtual machine,
wherein the first approach routes the networking packet over the hardware I/O bus from the first virtual machine to the second virtual machine via a first direct memory access (DMA) operation to copy the networking packet from the first memory portion to the hardware NIC and via a second DMA operation to copy the networking packet from the hardware NIC to the second memory portion.

5. The computing device of claim 1, further comprising:
an intermediary virtual machine; and,
a hardware memory having a first memory portion assigned to the first virtual machine and a second memory portion assigned to the second virtual machine,
wherein the intermediary virtual machine has privileges to access the first memory portion and the second memory portion,
wherein the second approach routes the networking packet through the intermediary virtual machine from the first virtual machine to the second virtual machine intermediary virtual machine via the intermediary virtual machine retrieving the networking packet from the first memory portion and copying the networking packet to the second memory portion.

6. The computing device of claim 1, wherein the first virtual machine is to notify the hardware NIC that the first virtual machine has constructed the networking packet,
and wherein in response to notification from the first virtual machine, the hardware NIC is to determine whether the first approach or the second approach should be used to route the networking packet.

7. The computing device of claim 1, further comprising:
a hardware input/output (I/O) bus to which the hardware NIC is communicatively connected; and,
a hardware memory having a first memory portion assigned to the first virtual machine and a second memory portion assigned to the second virtual machine,
wherein the hardware NIC is to perform a direct memory access (DMA) operation over the hardware I/O bus to retrieve just a portion of the networking packet from the first memory portion, and is to determine whether the first approach or the second approach should be used to route the networking packet based on contents of the portion of the networking packet.

8. The computing device of claim 1, wherein the considerations comprising one or more of:
currently available capacity of one or more processors of the computing device via which the first virtual machine and the second virtual machine;
current congestion on a hardware input/output (I/O) bus to which the hardware NIC is communicatively connected;
quality of service (QoS) requirements of the first virtual machine;
QoS requirements of the second virtual machine.

9. A computer-readable storage medium having computer-readable code stored thereon, wherein execution of the computer-readable code by a computing device causes a method to be performed, the method comprising:
programming a hardware network interface controller (NIC) of a computing device to determine whether a networking packet is to be routed from a first virtual machine of the computing device to a second virtual machine of the computing device in accordance with a first approach or a second approach, based upon one or more considerations regarding a state of the computing device,
wherein responsive to the networking packet being generated by the first virtual machine for transmission to the second virtual machine,
the hardware NIC is to determine whether the networking packet is to be routed in accordance with the first approach or the second approach, as programmed, and is then to control routing of the networking packet in the accordance with the first approach or the second approach.

10. The computer-readable storage medium of claim 9, wherein the first approach comprises routing the networking packet over a hardware input/output (I/O) bus of the computing device from the first virtual machine to the second virtual machine,
and wherein the second approach comprises routing the networking packet from the first virtual machine to the second virtual machine by using a computer program and a processor of the computing device to execute the computer program.

11. The computer-readable storage medium of claim 9, wherein the first approach does not use any processors of the computing device to route the networking packet from the first virtual machine to the second virtual machine,
and wherein the second approach does use one or more processors of the computing device to route the networking packet from the first virtual machine to the second virtual machine.

12. The computer-readable storage medium of claim 9, wherein the second approach comprises:
performing a first direct memory access (DMA) operation to copy the networking packet from a first memory portion of a hardware memory of the computing device assigned to the first virtual machine to the hardware NIC; and,
performing a second DMA operation to copy the networking packet from the hardware NIC to a second memory portion of the hardware memory assigned to the second virtual machine.

13. The computer-readable storage medium of claim 9, wherein the first approach comprises:
retrieving, by an intermediary virtual machine, the networking packet from a first memory portion of a hardware memory of the computing device assigned to the first virtual machine; and,
copying, by the intermediary virtual machine, the networking packet to a second memory portion of the hardware memory assigned to the second virtual machine.

14. The computer-readable storage medium of claim 9, wherein the considerations comprising one or more of:
currently available capacity of one or more processors of the computing device via which the first virtual machine and the second virtual machine;
current congestion on a hardware input/output (I/O) bus to which the hardware NIC is communicatively connected;
quality of service (QoS) requirements of the first virtual machine;
QoS requirements of the second virtual machine.

15. A hardware network interface controller (NIC) for a computing device comprising:
a first networking component implemented at least in hardware, to route a first networking packet sent by a first virtual machine of the computing device over a network external to the computing device;
a second networking component implemented at least in the hardware, to determine whether a second networking packet sent by the first virtual machine to a second virtual machine of the computing device is to be routed from the first virtual machine to the second virtual machine in accordance with a first approach or a second approach, based upon one or more considerations regarding a state of the computing device.
